(19) United States
(12) Patent Application Publication
(10) Pub. No.: US 2017/0318976 A1
(43) Pub. Date: Nov. 9, 2017

(54) Knee Sling

(71) Applicant: Lynn Journey, Lititz, PA (US)

(72) Inventor: Lynn Journey, Lititz, PA (US)

(21) Appl. No.: 15/148,279

(22) Filed: May 6, 2016

(51) Int. Cl. A47C 16/02; A61H 3/00

(52) U.S. Cl. CPC A47C 16/025; A61H 3/008

(57) ABSTRACT

A sling for use with wheeled walker is disclosed. The sting reversibly attached to the two handles of a walker and forms a sling in which a user can place a leg. When a user cradles an injured or otherwise burdened leg in the nadir of the sling, the stress on their joints is partially alleviated and their upright stability is supported, The sling is removable and adjustable by the user and may be cleaned and disinfected as necessary, allowing it to be used and reused by those in a rehabilitation of assistive care facility.

### FIELD OF THE INVENTION

The subject matter of this application pertains to devices and methods for using such devices by those with one damaged or otherwise burdened leg. In particular, the subject matter of this application pertains to a device and method for using such device which, when reversibly attached to a frame such as that of a mobility wheeled walker, forms a support which can cradle and support the damaged or otherwise burdened leg and thereby increase the user's stability and mobility.

### BACKGROUND

People who have lower extremity fractures, diabetic foot wounds, below the knee amputations or any of several other injuries or conditions may be incapable of placing weight on their afflicted side. Although one could use a wheelchair, many such people prefer to maximize their mobility, as well as their physical activity, by using a less restrictive mobility assist devices. Crutches are the most common mobility assist device. In use, a person partially supports their weight on the crutches, typically with the largest fraction of their weight distributed between their unaffected leg and their underarms which rest on the crutches' arm pads, and with a smaller fraction of their weight supported by their hands pressing on the crutches' handles. Although useful, crutches have the disadvantage of partially immobilizing the user's arms. Crutches can require careful attention by the user, at least when first adjusting to their use, to adequately shift weight and maintain stability when moving.

Wheeled walkers may be used by people who need some extra support, but can place weight on each of their legs. Further, people using wheeled walkers to avoid placing weight on one of their legs are at risk for other injuries due the unbalanced nature of their actions which can cause or aggravate shoulder injuries, and injuries to the weight-bearing hip and leg joints. At least one sling, the subject matter of US Patent Publication No.: US 2012/0048318, has been designed to allow those who cannot place any weight on one of their legs to use a standard wheeled walker. Such slings may comprise a solid, or partially solid, support to hold the non-weight-bearing leg along with other hardware making cleaning and sterilization difficult, increasing the effort and complexity needed to adjust the unit for a user, and also increasing the price of the unit.

Rolling knee walkers are an alternative device used by some with only one afflicted leg. A typical knee walker is similar in design to a wheeled scooter with a kneepad either to the left or right of center. Rolling knee walkers have a large turning radius and can be difficult for less-dextrous users to operate which may make them an unattractive option for some. Rolling knee walkers are also usually not covered by Medicare.

### SUMMARY

The subject matter of this application pertains to devices and methods of using these devices to support a leg. More particularly, the subject matter of this application pertains to slings and similar supportive devices which may reversibly attach to a wheeled walker in such a way that the user can rest or support one leg on the sling while the user's weight is supported by the other leg and by the wheeled walker itself.

One objective of the subject matter of this application is to provide a sling or similar device by which users may support an afflicted or weakened leg, most preferably in connection with a standard wheeled walker. Another objective of the subject matter of this application is to provide such a sling which can be easily removed and cleaned as necessary. Another objective of the subject matter of this application is to provide a minimalist sling which accomplishes the other objectives and does so at an affordable price point such that insurance coverage of the item is no, or a very minor, concern to patients.

The device and method disclosed in this application meet these objectives. The subject matter of this application comprises a strap which easily and reversibly extends across the hand grips of a standard wheeled walker, forming a sling which supports the user's afflicted or weakened leg. The strap is predominately constructed of a strengthened or reinforced strip of flexible material.and is held in place on the wheeled walker by a combination of friction and gravity, as well as one or more means of attachment. In its simplest embodiment, the material wraps around a wheeled walker's handle grips and is reversibly secured to itself, forming a loop. The user's leg would rest in this loop's nadir. Preferably, the strap comprises a slip-resistant material of sufficient strength to support the user. Most preferably the strap is capable of supporting at least 136 kg, or roughly the same amount of weight a standard wheeled walker can support. Alternative embodiments further comprise one or more stabilization straps which can be secured to features of a wheeled walker to increase the sling's stability. All embodiments require minimal effort and dexterity to attach, or remove, from the wheeled walker. The slings may be cleaned in place on the wheeled walker, or preferably, removed for cleaning. Most useful embodiments comprise at least one component that can be cleaned in a standard washing machine. Non-washing machine safe components may be cleaned by hand. The ease of removal, cleaning, and attachment allows the subject matter of this application to be used in rehabilitation or nursing home situations for multiple patients.

### BRIEF DESCRIPTION OF THE DRAWINGS

FIG. 1 is an illustration of the subject matter of this application showing the sling in place on a wheeled walker.

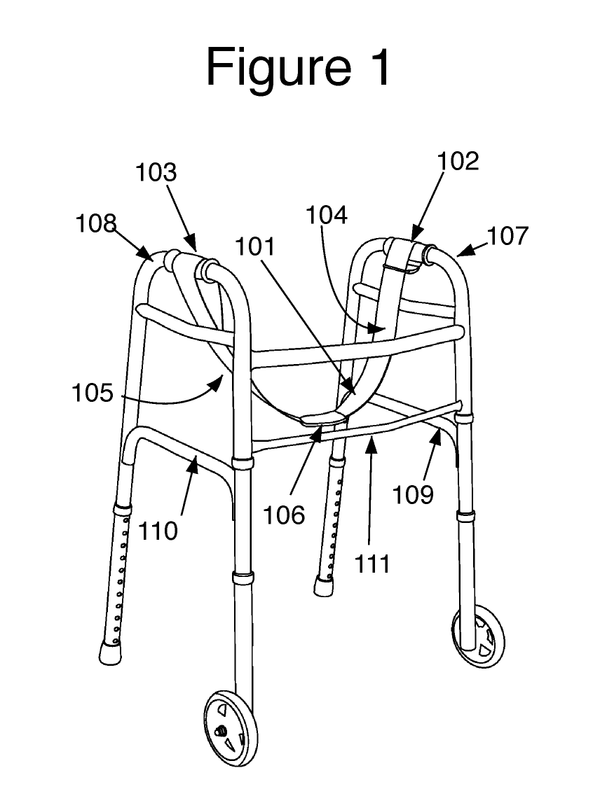

FIG. 2 is a view of the sling, unattached to a wheeled walker.

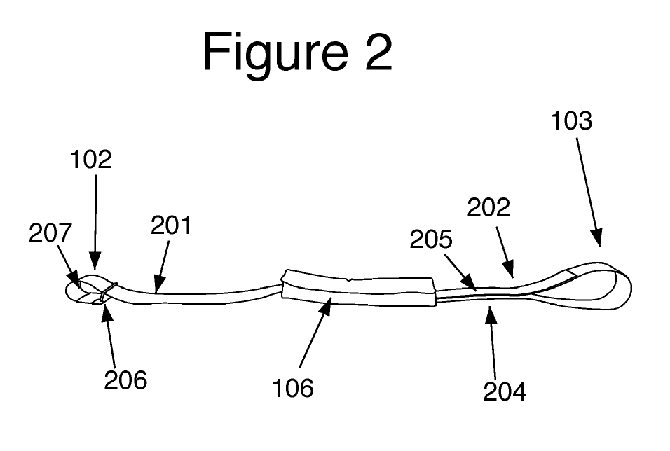

FIG. 3 is a top plan view of a sling further comprising additional securing straps.

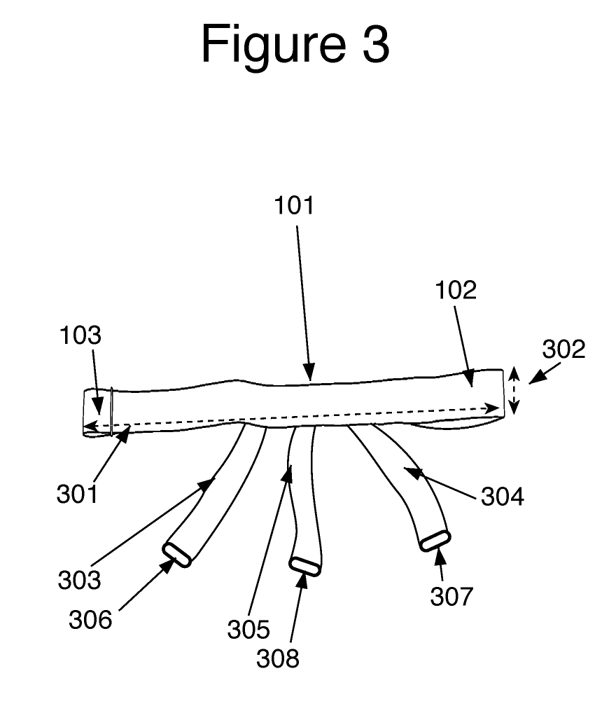

### DETAILED DESCRIPTION OF THE DRAWINGS

The following description and drawings referenced therein illustrate embodiments of the application's subject matter. They are not intended to limit the scope. Those familiar with the art will recognize that other embodiments of the disclosed method are possible. All such alternative embodiments should be considered within the scope of the application's disclosure.

Each reference number consists of three digits. The first digit corresponds to the figure number in which that reference number is first shown. Reference numbers are not necessarily discussed in the order of their appearance in the figures.

The subject matter of this application pertains to devices which at least partially support an injured or otherwise burdened leg. In particular, the subject matter of this application attaches to a wheeled walker and supports the user's injured or otherwise burdened leg. This assistive support partially alleviates the user's reliance on their other leg and arms to steady themselves and maintain their balance. This alleviation further allows the user the remove one or both hands from their wheeled walker in order to interact with the world by lessening the risk of falling. The subject matter of this application further pertains to such supportive devices which can be attached and removed from a wheeled walker with a minimum of effort and which are comprised of materials which can be laundered or cleaned without the need for specialized equipment.

For ease in drafting and hopefully, in reading, the subject matter of this application is referred to as a sling. This sling comprises structures and features as detailed.

The sling comprises a body (101) having a breadth (401) and a width (402), a first wheeled walker attachment means (102), and a second wheeled walker attachment means (103). The body comprises a top surface (104), a bottom surface (105), a first side (201), and a second side (202). Each of the sides further comprises a terminus. Preferred embodiments further comprise a cushioned kneepad (106) which may be fixed along the sling's body or may be capable of moving along the sling's body.

In some embodiments, at least one of the body's sides further comprises one member of a two member fastening system (204). In these embodiments, the complementary member of the two member fastening system (205) is also located on the sling's body such that engaging the two member fastening system closes a loop formed by the sling's body.

In the most preferred embodiment the sling body's first side's terminus comprises a slide fastener such as a lashing point, D-ring, slide, loop, or similar structure (206) most commonly made of a hard plastic or metal. In this embodiment, the first wheeled walker attachment point is formed by the sling body's second side wrapping around one of the wheeled walker's handles (107) and passing though the fastening structure (206) and pulled tight, thereby forming a loop (207) around the wheeled walker's handle by the sling's first side. The sling body's second side is then wrapped around the wheeled walker's other handle (107) such that the sling's span between the wheeled walker's handles forms a nadir in which the user's knee is cradled. Also a portion of the sling's body's second side's bottom face comprises one member of a two-member fastening system (204) which is paired with the other member of a two-member fastening system (205) located on the body's bottom face such that reversibly attaching these fastening members closes the loop surrounding the wheeled walker's handle and comprising the second wheeled walker attachment means (103). In a most preferred embodiment, a cushioned kneepad (106) may be moved over the sling's nadir to more gently cradle the user's knee.

In most preferred embodiments, slipping of the sling as the user moves is reduced by having the sling's body comprise a rubberized material such as a reinforced rubberized webbing. The sling's body may be comprised or such rubberized material may in part of in whole, provided that the rubberized material contact the wheeled walker's handles when in use.

In some alternative embodiments the sling's body may further comprise one or more auxiliary connection straps which may be attached to points on a wheeled walker other than the two handles to decrease horizontal movement of the sling. In a preferred embodiment, the sling's body comprises three such auxiliary straps: a first strap (303) and a second strap (304), each of which comprises an attachment means (306, 307) which can attach to first (109) and second (110) non-handle lateral attachment points on a wheeled walker, and a third strap (305) comprising an attachment means (308) which can connect to a third attachment point (111) on a wheeled walker.

We claim:

1. A sling for supporting a knee comprising a body having a breadth and a width, a top surface, a bottom surface, a first side, and a second side,
a) said first side comprising a first attachment means,
b) said second side comprising a second attachment mean,
c) said first attachment means capable of being reversibly attached to a handle of a wheeled walker, and the second attachment means capable of being reversibly attached to the other handle of a wheeled walker such that the breadth of the sling's body forms a nadir centered between the first and second attachment means.

2. The sling of claim 1 in which the first side further comprises a slide fastener and in which the first attachment means is a loop surrounding a handle of a wheeled walker formed by looping the sling's body over the handle and through the slide fastener.

3. The sling of claim 1 in which the body's second side's bottom face comprises one member of a two member fastening system and the body's bottom face further comprises the second member of a two member fastening system at approximately the said nadir,
a) such that the second attachment means is a loop surrounding a handle of a wheeled walker's

4. The sling of claim 1 further comprising a cushioned pad positionable to the sling's nadir.

5. The sling of claim 1 further comprising at least one auxiliary strap comprising a first end and a second end,
a) said first end connected to the sling's body at approximately the level of the nadir and,
b) said second end comprising an attachment means capable of being reversibly attached to a point on a wheeled walker other than a handle.

6. The sling of claim 1 in which the sling's body comprises a non-skid flexible material capable of supporting at least 136 kilograms.
